(19) United States
(12) Patent Application Publication
(10) Pub. No.: US 2013/0309622 A1
(43) Pub. Date: Nov. 21, 2013

(54) DEVICE FOR PREHEATING CHARGING MATERIALS FOR GLASS MELTING FACILITIES

(71) Applicants: Matthias Lindig, Ingelheim (DE); Helmut Sorg, Glattbach (DE)

(72) Inventors: Matthias Lindig, Ingelheim (DE); Helmut Sorg, Glattbach (DE)

(21) Appl. No.: 13/824,755

(22) PCT Filed: Dec. 13, 2011
(86) PCT No.: PCT/EP2011/072528

§ 371 Date: Apr. 17, 2013

(30) Foreign Application Priority Data
Dec. 22, 2010 (DE) 10 2010 055 685.8

(51) Int. Cl. F27D 7/02

(52) U.S. Cl. CPC F27D 7/02
USPC 432/120

(57) ABSTRACT

A device for preheating charging material for glass melting installations using its exhaust gases, having a vertical preheating shaft through which a heat exchanger extends conducting exhaust gases, the shaft upper end having a charging material opening, the lower end having a preheated charging material discharge device, the inlet of the heat exchanger connected to an exhaust gas supply line and the outlet connected to an exhaust gas outlet line. To recuperate a high portion of the exhaust gas heat, and to reduce environmental contamination and the suctioning of environmental air as false air, the exhaust gas supply line has an outlet line branch for drawing oft part of the hot gases and the outlet line is connected to a downwardly open sealing gas line in the region of the charging material above the heat exchanger exhaust gas passage for the hot gas emission into the charging material.

### CROSS-REFERENCES TO RELATED APPLICATIONS

This application claims the benefit of German patent application No. 10 2010 055 685.8 filed on Dec. 22, 2010, the entire disclosures of which are incorporated herein by way of reference.

### BACKGROUND OF THE INVENTION

A device for preheating particulate charging material for glass melting installations using the exhaust gases thereof, having a vertical preheating shaft through which there extends a heat exchanger through which the exhaust gases are conducted, the exhaust gas passage of the heat exchanger, which is protected against the penetration of particles, having openings along its circumference, and the upper end of the preheating shaft having a charging opening for the charging material, and the lower end having a discharge device for the preheated charging material, and the inlet of the at least one exhaust gas passage of the heat exchanger being connected to a supply line and the outlet being connected to an outlet line for the exhaust gases.

The preheating of charging material before its feeding into glass melting installations presents, with regard to its parameters and geometries, a complex and difficult-to-control constellation of influences from the areas of chemistry and physics. Thus, the charging material can contain components having very different particle sizes, ranging from dust up to briquettes, having very different melting points and mixing characteristics, and having differing quantities of free and bound water. The heating by heating gases, preferably by exhaust gases from burners from the melt region, for the recuperation of heat from temperature ranges up to 1600° C. and possibly even higher, is also an important precondition for saving thermal energy and for reducing atmospheric stress due to toxic gases such as toxic CO and nitrogen compounds. The retention of dust from exhaust gases of the melt chamber and the preheating zone is also of increasing importance. In addition, water, or water vapor, can form both in the melt chamber and in the preheating area, and/or may be released, because free and/or bound water can for example be introduced via the charging material. The consequences range from clumping of the charging material up to process disturbances that are difficult to remedy. In addition, false air suctioned from the atmosphere can also be disturbing, because it has for example a negative influence on the thermal balance, or promotes the release of dust and blocks degasification. Finally, interactions between the glass components and the component materials also play an important role, and here relative speeds are influential.

From DE 40 07115 C2, it is known to preheat bulk material for glass melting processes in vertical shafts through which horizontal hot gas channels are led in a plurality of tiers, these channels being downwardly open. The exhaust gas from the downstream melt process is introduced into these channels in the same directions. On the lower side of the hot gas channels, the exhaust gas exits and, after flowing through the bulk material, is reintroduced into the lower openings of the hot gas channels situated thereover in each case, and is again suctioned in the same direction. The climbing line for the hot gas ends in the head region at terminals that are however not connected to lines, so that the distribution corresponds mainly to the local flow resistances in the bulk material; moreover, this also holds for all other flow paths between the individual tiers. Due to the series connections of the flow paths and the use of a suction ventilator, an underpressure is produced in the system that further reinforces the undesirable effect of the drawing in of false air.

### SUMMARY OF THE INVENTION

Therefore, the object of the present invention is to create a device for preheating particulate charging material for glass melting installations of the type named above in which a large portion of the heat is recuperated from the exhaust gases, having a low constructive height and low volume, and in which the suctioning in of environmental air as false air, and environmental contamination, is reduced to a minimum. Moreover, already-existing devices of this type are to be easily retrofitted or converted.

According to the present invention, this object is achieved in that the supply line for the exhaust gases has at least one branch in the form of an outlet line for the drawing off of a partial quantity of the high gases, and that the outlet line is connected to at least one downwardly open sealing gas line that is situated in the region of the charging material above the at least one exhaust gas passage for the emission of the hot gases into the charging material. The suctioning of false air into the charging material can be largely prevented by the sealing gas. This technical effect is further reinforced with the aid of the embodiments of the present invention described below.

Thus, according to the present invention a plurality of exhaust gas passages of the heat exchanger are situated parallel to one another in one or more horizontal tiers in the preheating shaft.

It has also proven advantageous that the at least one exhaust gas passage of the heat exchanger be connected at its removal side to an induced draft whose suction power is regulated by a pressure sensor. In this way, pressure losses during the conducting of the hot gases through the heat exchanger can be compensated.

In a development of the idea of the present invention, it is provided that the outlet line is connected to the supply line for the exhaust gases to the preheating shaft. In this way, in the branched-off partial flow there prevails approximately the same underpressure as in the exhaust gas flow in the supply line to the heat exchanger.

In order to make it possible to adjust the quantity of the branched-off partial flow, according to the present invention it is provided that a throttle is situated in the outlet line.

According to a further embodiment of the present invention, the sealing gas lines are sealed at their ends inside the preheating shaft. This makes possible a directed exit of the hot gases into the charging material.

In order to ensure a secure introduction of the exhaust gases into the charging material even given inadequate pressure conditions, according to the present invention it is provided that a pressure-producing device is situated in the outlet line. This can usefully be a hot gas blower.

It has proven advantageous that for the regulation of the drawing off of the exhaust gases via the downwardly open sealing gas lines, the pressure-producing unit be connected to a pressure sensor that extends into the charging material above the sealing gas lines.

In order to enable a constant equilibrium of flow and pressure inside the preheating shaft, according to the present invention it is provided that a plurality of sealing gas lines be distributed over the cross-section.

### BRIEF DESCRIPTION OF THE DRAWINGS

The present invention and its advantages are explained in more detail in the following on the basis of two exemplary embodiments and their manner of operation and advantages, illustrated in the drawing.

FIG. 1 shows, in a schematic representation, a vertical section through a device according to the present invention for preheating the charging material of glass melting installations, made up of a preheating shaft having allocated aggregates,

FIG. 2 shows a representation corresponding to FIG. 1 of a further specific embodiment of a device according to the present invention having a hot gas blower, and

FIG. 3 shows a horizontal section through the preheating shaft in the area of the sealing gas lines shown in FIGS. 1 and 2.

### DETAILED DESCRIPTION OF THE PREFERRED EMBODIMENTS

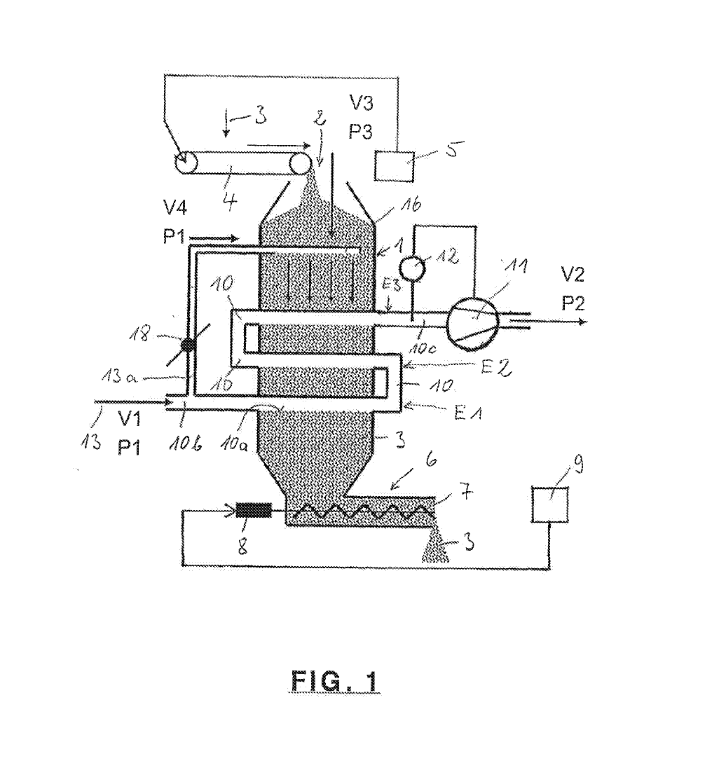

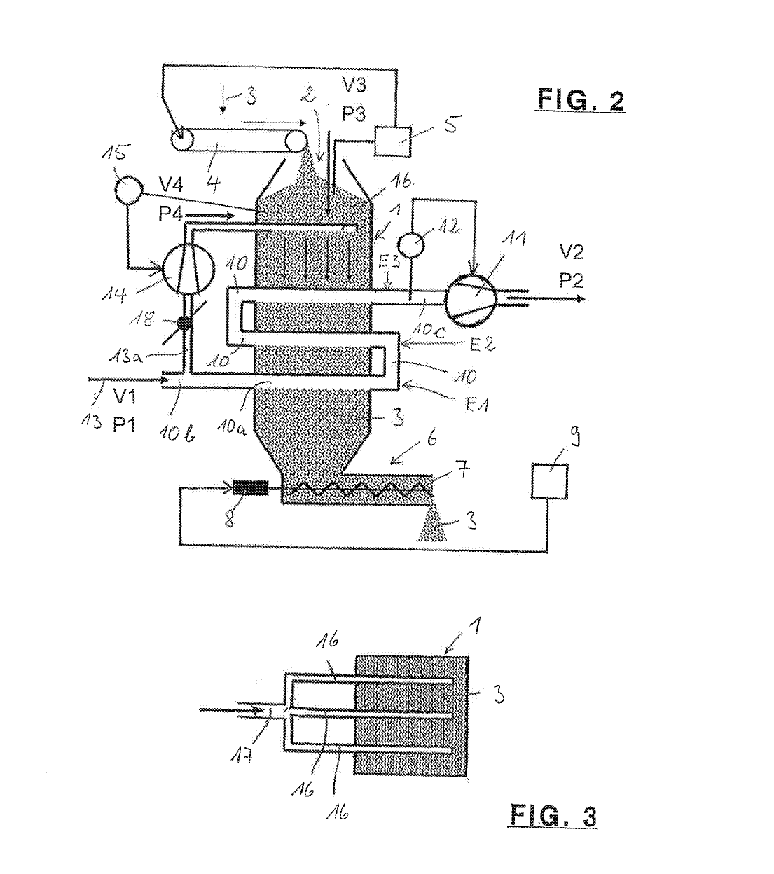

FIG. 1 shows a preheating shaft 1 that has at its upper end a charging opening 20 for charging material 3, which forms a sinking column in preheating shaft 1. The supply of charging material takes place via a belt conveyor 4 whose conveying speed is regulated via a filling state sensor 5 in such a way that charging opening 2 does not become sealed. At the lower end, there is situated a discharge device 6 for the preheated charging material 3. This device has a conveyor screw 7 driven by a motor 8. The rotational speed thereof, and thus the conveyed quantity per time unit, is controlled via a sensor 9 that is connected to a filling state measuring device at a tub for the glass melt, which is not shown. Preheating shaft 1 is outwardly thermally insulated, so that the greater part of the supplied quantity of heat is transmitted to charging material 3. The movement of this material in preheating shaft 1 takes place through the action of gravity.

The preheating of charging material 3 is accomplished by very hot exhaust gases from the melt chamber, also called heating gases or hot gases 13, which are conducted through preheating shaft 1 via a system of lines described below. In the described exemplary embodiment, in preheating shaft 1 there are situated tube-shaped exhaust gas passages 10 in three tiers E1, E2, and E3, acting as a heat exchanger, of which in each tier there are situated at least two exhaust gas passages 10 whose axes are each situated in a horizontal plane. These exhaust gas passages 10 are provided inside preheating shaft 1 with downward openings 10a that permit the hot exhaust gases to escape. The number of tiers may be one, two, or more.

Instead of a tube-shaped cross section, the exhaust gas passages can also have a box-shaped or rhomboidal profile, or some other cross-section.

At supply side 10b of preheating shaft 1, the hot exhaust gases coming from the melt installation (not shown) enter into the at least one exhaust gas passage 10 and are first supplied to lowest tier E1, and flow through the heat exchanger in a co-current flow, a counter-flow, a cross-counter flow, or a simple cross-flow. The exhaust gas leaves exhaust gas passage 10 at its outlet side 10c, from where the exhaust gas is conducted to a depicted cleaning system, and finally to a chimney. The pressure losses that arise due to friction when the exhaust gases are conducted through the tube-shaped heat exchanger are compensated by an induced draft 11 whose suctioning power is regulated by a pressure sensor 12 that determines the pressure in charging material 3 at the upper end of preheating shaft 1. In this way, it is ensured that a slight underpressure always prevails in exhaust gas passage 10 or in hot gas 13.

From exhaust gas passage 10, via an outlet line 13a a partial quantity of hot gas 13 is branched off and supplied to a sealing gas line 16 situated above exhaust gas passage 10. On the underside of sealing gas line 16, which is sealed at its ends, there are fashioned openings through which the exhaust gas is blown into charging material 3, as indicated by four arrows. This gas release is also referred to as sealing gas. The quantity of partial flow V4 branched off to sealing gas line 16 can be adjusted using a throttle 18.

Tube-shaped exhaust gas passages 10 shown in the depicted exemplary embodiment are designed in such a way, and induced draft 11 is controlled in such a way, that no underpressure arises above sealing gas line 16 relative to ambient atmospheric pressure P3, so that no false air V3 can be suctioned through charging opening 2. As is shown in FIG. 3, exhaust gas passages 10 and sealing gas lines 16 can also be situated multiply alongside one another in horizontal tiers that run perpendicular to the plane of the drawing. These embodiments ensure that a constant equilibrium of flow and pressure is present inside preheating shaft 1, largely preventing a suctioning of cold false air through charge opening 2. If the underpressure present in outlet line 13a is not adequate, the draft in the outlet line can be modified, in particular increased, by an additionally provided hot gas blower 14.

FIG. 3 shows that in the depicted exemplary embodiment three sealing gas lines 16 are connected to a main line 17 in the configuration of a horizontal fork. Sealing gas lines 16 are very uniformly distributed over the quadratic cross-section of preheating shaft 1.

In the following, the functioning of the device is described in more detail.

Hot exhaust gas flow V1, from the glass melting installation (not shown), is conducted in exhaust gas supply line 10b to the device for preheating charging material 3. Here, an underpressure P1 prevails at supply side 10b of preheating shaft 1. Exhaust gas passages 10 of the heat exchanger itself represent a flow resistance. Therefore, a further pressure loss builds up in the system of exhaust gas passages. At outlet side 10c of the heat exchanger, exhaust gas flow V2 has an underpressure P2 that is greater than underpressure P2. The underpressure prevailing in exhaust gas passages 10 of the heat exchanger can be modified by induced draft 11.

From exhaust gas flow V1 supplied to the heat exchanger, a partial flow V4 is branched off via outlet line 13a. This partial flow has approximately the same underpressure as does exhaust gas flow V1 in exhaust gas supply line 10b. The pressure difference between P1 and P2 is normally sufficient to suction partial flow V4.

Due to the natural pressure difference in partial flow V4 relative to the exhaust gas flow, hot gas 13 in the uppermost tier of preheating shaft 1 escapes via sealing gas lines 16 from the heat exchanger into charge material 3. The exhaust gas flow emitted into the charge material is at the underpressure level of P2. In the absence of additional pressure losses, partial flow V4 is at level P1. The quantity of partial flow V3 can be adjusted via throttle 18, as stated above.

In order to increase the underpressure in outlet line 13a, in addition a hot gas blower 14 can be situated in the outlet line. The quantity of partial flow V4 can in this way be regulated in such a way that over sealing gas lines 16 there arises a pressure that corresponds approximately to ambient pressure (atmospheric pressure) P3. Through hot gas blower 14 and sealing gas lines 16, a not yet significantly cooled partial flow V3 of hot gases 13, which can be for example 10v% of the total quantity of the supplied hot gases, is brought to a lower underpressure compared to exhaust gas flow 13.

Due to the pressure conditions in the bulk material, partial flow V4 moves out of sealing gas lines 16 in the direction of the arrows downward to exhaust gas passages 10, through which the main quantity of hot gases 13 is conducted. In this way, the suctioning of false air V3 through charge opening 2 is largely prevented, and the height of the material over sealing gas lines 16 can be significantly reduced so that the volume and constructive height of preheating shaft 1, and thus its constructive costs, can be correspondingly reduced.

In particular, existing preheating installations can be easily and economically retrofitted through the subsequent installation of such sealing gas lines 16, thus reducing their operating costs. The essential advantage of the present invention is to keep the portion of false air small so that

a) the height of charge material 3 over the heat exchanger can be kept small, reducing the constructive height and thus also reducing costs,

b) a partial flow of the existing hot gas is used as a sealing gas to prevent a drawing in of false air, and

c) the efficiency of the glass melting installation is increased and the environment is protected.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 preheating shaft
2 charge opening
3 charge material
4 belt conveyor
5 filling state sensor
6 discharge device
7 conveyor screw
8 motor
9 sensor
10 exhaust gas passage (heat exchanger)
10a opening
10b supply side (exhaust gas supply)
10c outlet side
11 induced draft
12 pressure sensor
13 hot gases (exhaust flow)
13a outlet line (branch line)
14 hot gas blower
15 pressure sensor
16 sealing gas lines
17 main line for 16
18 throttle
V1 exhaust gas flow in the supply line to the heat exchanger
V2 exhaust gas flow after the heat exchanger
V3 false air
V4 partial flow
E1 tier
E2 tier
E3 tier
P1 underpressure
P2 underpressure
P3 atmospheric pressure

1-10. (canceled)

11. A device for preheating particulate charging material for glass melting installations using hot exhaust gases thereof, comprising:
a vertical preheating shaft through which there extends a heat exchanger through which the exhaust gases are conducted,
the heat exchanger having at least one exhaust gas passage, which is protected against the penetration of particles, and having openings along its circumference,
an upper end of the preheating shaft having a charging opening for the charging material,
a lower end of the preheating shaft having a discharge device for preheated charging material,
an inlet of the at least one exhaust gas passage of the heat exchanger being connected to an exhaust gas supply line and an outlet being connected to an outlet line for the exhaust gases,
the supply line for the exhaust gases having at least one branch in the form of an outlet line for drawing off a partial quantity of the hot gases,
the outlet line being connected to at least one downwardly open sealing gas line that is situated in a region of the charging material above the at least one exhaust gas passage for the emission of the hot gases into the charging material.

12. The device as recited in claim 11, wherein a plurality of exhaust gas passages of the heat exchanger are situated parallel to one another in one tier or a plurality of horizontal tiers in the preheating shaft.

13. The device as recited in claim 11, wherein the at least one exhaust gas passage of the heat exchanger is connected at its outlet side to an induced draft whose suction power is regulated by a pressure sensor.

14. The device as recited in claim 11, wherein the outlet line is connected to the supply line for the exhaust gases to the preheating shaft.

15. The device as recited in claim 11, wherein in the outlet line there is situated a throttle with which the quantity of the branched-off partial flow is adjustable.

16. The device as recited in claim 11, wherein the sealing gas lines are sealed at their ends inside the preheating shaft.

17. The device as recited in claim 11, wherein a pressure-producing device is situated in the outlet line.

18. The device as recited in claim 17, wherein the pressure-producing device is a hot gas blower.

19. The device as recited in claim 11, wherein for the regulation of the drawing off of the exhaust gases via the downwardly open sealing gas lines, the pressure-producing device is connected to a pressure sensor that extends above the sealing gas lines into the charging material.

20. The device as recited in claim 11, wherein a plurality of sealing gas lines are distributed over a cross-section of the preheating shaft.
